(19) United States
(12) Patent Application Publication
(10) Pub. No.: US 2021/0024388 A1
(43) Pub. Date: Jan. 28, 2021

(54) ADVANCED OXIDATION WATER TREATMENT SYSTEM AND METHOD

(71) Applicants: Kabushiki Kaisha Toshiba, Minato-ku (JP); Toshiba Infrastructure Systems & Solutions Corporation, Kawasaki-sh i (JP)

(72) Inventors: Seiichi MURAYAMA, Fuchu (JP); Naohiko SHIMURA, Fuchu (JP); Kanako MORITANI, Yokohama (JP); Ryutaro MAKISE, Yokohama (JP)

(73) Assignees: Kabushiki Kaisha Toshiba, Minato-ku (JP); Toshiba Infrastructure Systems & Solutions Corporation, Kawasaki-shi (JP)

(21) Appl. No.: 17/067,078

(22) Filed: Oct. 9, 2020

Related U.S. Application Data
(63) Continuation of application No. PCT/JP2019/016061, filed on Apr. 12, 2019.

(30) Foreign Application Priority Data
Apr. 12, 2018 (JP) 2018-076860

(51) Int. Cl. C02F 1/78; C02F 1/72; C02F 1/68

(52) U.S. Cl. CPC C02F 1/78; C02F 1/722; C02F 1/686; C02F 2101/301; C02F 2201/784; C02F 2303/02; C02F 2303/04; C02F 2201/782

(57) ABSTRACT

An advanced oxidation water treatment system includes an ozone reaction tank; a first hydrogen peroxide supplier which supplies hydrogen peroxide to treatment water in a supply line supplying the treatment water to the ozone reaction tank; an ozone generator which generates and supplies an ozonized gas containing ozone to the ozone reaction tank; a second hydrogen peroxide supplier which can supply additional hydrogen peroxide to the ozone reaction tank downstream of where the ozonized gas is supplied; a meter which measures water quality of the treatment water at a location downstream of where the ozonized gas is supplied; and a controller which determines whether and how much additional hydrogen peroxide is to be supplied by the second hydrogen peroxide supplier based on the water quality measured by the meter, and to control the second hydrogen peroxide supplier accordingly.

### CROSS-REFERENCE TO RELATED APPLICATIONS

This application is a continuation of International Application No. PCT/JP2019/016061, filed Apr. 12, 2019 which claims the benefit of priority from Japanese Patent Application No. 2018-076860, filed on Apr. 12, 2018, the entire contents of which are incorporated herein by reference.

### FIELD

Embodiments described herein relate generally to an advanced oxidation water treatment system and a method.

### BACKGROUND

Conventionally, ozone has been used for treatment such as oxidative decomposition of organic matter in the water, sterilization, deodorization, and the like in the field of water supply, sewage, industrial waste water, pools, and the like. However, even with oxidation with ozone, making matter inorganic is unfeasible, although hydrophilization and molecular weight reduction are feasible. In addition, persistent organic matter such as dioxin and 1,4-dioxane cannot be decomposed.

In decomposing the persistent organic matter described above, one effective method is to perform oxidative decomposition using OH radicals, which are more oxidative than ozone.

In the field of water treatment, to generate OH radicals, a method that irradiates ozone-containing water with UV rays, a method that adds ozone to hydrogen peroxide-containing water, a method that irradiates hydrogen peroxide-containing water with UV rays, and a method that uses hydrogen peroxide, ozone, and UV rays all in combination are generally used.

Among these methods, the method using ozone and hydrogen peroxide is known as effective in inhibition of the generation of bromic acid ions as a by-product of ozone treatment such as treatment for water supply. Advanced water purification treatment using ozone, for example, is being widely operated domestically and internationally as an anti-musty smell measure or an anti-trihalomethane measure but involves bromic acid generation risk. Normally, an ozone addition rate is changed in accordance with the concentration of substances to be treated; when the bromic acid generation risk, which is a sterilization by-product of the ozone treatment, is high by the influence of source water quality, water temperature, and the like, efficient operation reducing an ozone addition amount is required. A measure therefor generates OH radicals, which have high oxidative power, by adding hydrogen peroxide, increases a decomposition rate of musty smell substances and the like to be treated by advanced oxidation treatment using them, and can thus, at the same time owing to reducing action on bromic acid by hydrogen peroxide, reduce the bromic acid generation risk.

### BRIEF DESCRIPTION OF DRAWINGS

FIG. 1 is a schematic diagram illustrating a configuration of an advanced oxidation water treatment system of a first embodiment;

FIG. 2 is an illustrative diagram of the advanced oxidation water treatment system when one ozone reaction tank is provided;

FIG. 3 is an illustrative diagram of the advanced oxidation water treatment system when water to be treated flows through the ozone reaction tank in a vertical direction;

FIG. 4 is a schematic diagram illustrating a configuration of the advanced oxidation water treatment system of a second embodiment;

FIG. 5 is a schematic diagram illustrating a configuration of the advanced oxidation water treatment system according to a modification of the second embodiment;

FIG. 6 is a schematic diagram illustrating a configuration of the advanced oxidation water treatment system of a third embodiment;

FIG. 7 is a schematic diagram illustrating a configuration of the advanced oxidation water treatment system of a fourth embodiment;

FIG. 8 is a schematic diagram illustrating a configuration of the advanced oxidation water treatment system of a fifth embodiment;

FIG. 9 is a schematic diagram illustrating a configuration of the advanced oxidation water treatment system of a sixth embodiment; and

FIG. 10 is a schematic diagram illustrating a configuration of the advanced oxidation water treatment system of a seventh embodiment.

### DETAILED DESCRIPTION

According to an embodiment, an advanced oxidation water treatment system includes an ozone reaction tank, a first hydrogen peroxide supplier, an ozone generator, a second hydrogen peroxide supplier, a first meter, and a controller. The ozone reaction tank holds treatment water to be treated. The first hydrogen peroxide supplier supplies hydrogen peroxide to treatment water in a supply line supplying the treatment water to an inlet of the ozone reaction tank. The ozone generator generates an ozonized gas containing ozone and supplies the ozonized gas to the ozone reaction tank downstream of the inlet. The second hydrogen peroxide supplier supplies hydrogen peroxide to the ozone reaction tank downstream of where the ozone generator supplies ozonized gas. The first meter measures water quality of the treatment water at a first location downstream of the inlet. The controller determines whether the hydrogen peroxide is to be supplied by the second hydrogen peroxide supplier and determines a supply amount of said any additional hydrogen peroxide to be supplied by the second hydrogen peroxide supplier based on the water quality measured by the first meter, and controls the second hydrogen peroxide supplier.

The following describes preferred embodiments in detail with reference to the accompanying drawings.

### First Embodiment

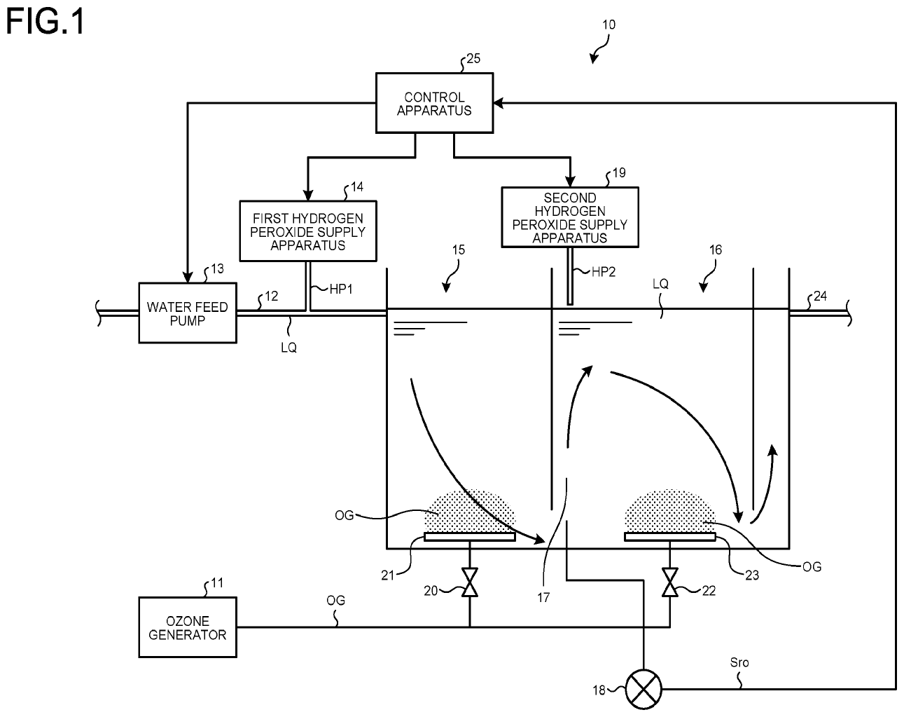

FIG. 1 is a schematic diagram illustrating a configuration of an advanced oxidation water treatment system of a first embodiment.

This advanced oxidation water treatment system 10 includes an ozone generator 11 discharging oxygen or dry air as a source gas to generate an ozone gas and supplying an ozonized gas (=O₃+O₂ or O₃+O₂+N₂) OG containing ozone gas, a water pump 13 supplying water (treatment water) LQ to be treated as a liquid to be treated via an inflow channel 12, and a first hydrogen peroxide supply apparatus 14 supplying hydrogen peroxide HP1 via the inflow channel 12. The water LQ to be treated can be expressed by raw water and includes river water, industrial wastewater, and domestic wastewater.

The advanced oxidation water treatment system 10 also includes a first ozone reaction tank 15 housing the water LQ to be treated, a second ozone reaction tank 16 housing the water LQ to be treated, an introduction channel 17 introducing the water LQ to be treated from the first ozone reaction tank 15 to the second ozone reaction tank 16, a dissolved ozone concentration meter 18 measuring a dissolved ozone concentration in the water to be treated, introduced into the introduction channel 17 after passing through the first ozone reaction tank 15, and outputting a dissolved ozone concentration measurement signal Sro, and a second hydrogen peroxide supply apparatus 19 supplying hydrogen peroxide HP2 in an amount to be additionally supplied calculated based on a measurement result of the dissolved ozone concentration meter 18 corresponding to the dissolved ozone concentration measurement signal Sro to the water to be treated.

The advanced oxidation water treatment system 10 further includes a first valve 20 adjusting a supply amount of an ozonized gas to be introduced to the first ozone reaction tank 15, a first gas diffusion unit 21 that is connected to the first valve 20, is placed at the bottom of the first ozone reaction tank 15, and supplies an ozonized gas in a bubble form into the first ozone reaction tank 15, a second valve 22 adjusting a supply amount of an ozonized gas to be introduced to the second ozone reaction tank 16, a second gas diffusion unit 23 that is connected to the second valve 22, is placed at the bottom of the second ozone reaction tank 16, and supplies the ozonized gas OG in a bubble form into the second ozone reaction tank 16, an outflow channel 24 causing the water LQ to be treated after being reacted in the second ozone reaction tank 16 to flow out, and a control apparatus 25 for controlling the entire advanced oxidation water treatment system 10.

The following describes operation of the first embodiment.

The control apparatus 25 controls the water feed pump 13 to supply the water LQ to be treated via the inflow channel 12.

In this process, the control apparatus 25 controls the ozone generator 11 so as to supply the ozonized gas OG with a certain ratio to a supply amount of the water LQ to be treated.

With this operation, the ozone generator 11 discharges oxygen or dry air as the source gas to generate the ozonized gas OG containing ozone gas. The ozone generator 11 supplies the ozonized gas OG to the first gas diffusion unit 21 placed within the first ozone reaction tank 15 via the first valve 20. Also, the ozone generator 11 supplies the ozonized gas OG to the second gas diffusion unit 23 placed within the second ozone reaction tank 16 via the second valve 22.

Consequently, a certain amount of the ozonized gas OG in a bubble form is supplied from the first gas diffusion unit 21 to the water LQ to be treated within the first ozone reaction tank 15.

Similarly, a certain amount of the ozonized gas OG in a bubble form is supplied from the second gas diffusion unit 23 to the water LQ to be treated within the second ozone reaction tank 16.

In concurrence therewith, the control apparatus 25 causes the first hydrogen peroxide supply apparatus 14 to supply the hydrogen peroxide HP1 with a certain ratio to the amount of the ozonized gas OG supplied to the first ozone reaction tank 15 and the second ozone reaction tank 16. In this case, the supply ratio of the hydrogen peroxide to ozone O₃ contained in the ozonized gas OG is preferably to be H₂O₂ (mol)/O₃ (mol)=1 to 5.

Consequently, OH radicals (.OH) are generated by ozone in the ozonized gas OG and the hydrogen peroxide supplied to the first ozone reaction tank 15.

Generation of OH radicals is attributable to Formula (1) or Formula (2):

O₃+H₂O₂→.OH+HO₂+O₂ (1)

H₂O₂→+H⁺+HO₂⁻

O₃+HO₂⁻→.OH+O₂⁻+O₂ (2)

Consequently, in the first ozone reaction tank 15, the generated OH radicals cause advanced oxidation treatment.

By the way, when the consumption of hydrogen peroxide in the first ozone reaction tank 15 exceeds a consumption at the normal time (the consumption normally estimated for the water LQ to be treated) owing to water quality and other factors, the amount of hydrogen peroxide introduced into the second ozone reaction tank 16 from the first ozone reaction tank 15 decreases, and thus hydrogen peroxide is insufficient relative to ozone to be supplied by the second gas diffusion unit 23 in the second ozone reaction tank 16.

In this case, a dissolved ozone concentration in the water LQ to be treated, introduced into the introduction channel 17 after passing through the first ozone reaction tank 15 becomes higher than a dissolved ozone concentration at the normal time.

Thus, the control apparatus 25 measures the dissolved ozone concentration in the water LQ to be treated, introduced into the introduction channel 17 after passing through the first ozone reaction tank 15, by the dissolved ozone concentration meter 18 in order to make an additional addition amount of the hydrogen peroxide (the amount of the hydrogen peroxide HP2) an optimum value. Consequently, the dissolved ozone concentration meter 18 outputs the dissolved ozone concentration measurement signal Sro corresponding to the measured dissolved ozone concentration to the control apparatus 25.

The control apparatus 25 then calculates a hydrogen peroxide amount corresponding to a shortage of the hydrogen peroxide initially supplied, that is, a shortage of OH radicals based on the difference between the measured dissolved ozone concentration corresponding to the dissolved ozone concentration measurement signal Sro and a normal dissolved ozone concentration.

The following describes setting of an addition rate (with a unit of mg/L, for example) as an addition amount per unit water amount of the ozonized gas, the hydrogen peroxide supplied by the first hydrogen peroxide supply apparatus 14, and the hydrogen peroxide supplied by the second hydrogen peroxide supply apparatus 19.

Here, the addition rate of the hydrogen peroxide (H₂O₂) by the first hydrogen peroxide supply apparatus 14 is defined as Ad_PH_1 (hereinafter, referred to as a first hydrogen peroxide addition rate Ad_PH_1), whereas the addition rate of the hydrogen peroxide by the second hydrogen peroxide supply apparatus 19 is defined as Ad_PH_2 (hereinafter, referred to as a second hydrogen peroxide addition rate Ad_PH_2).

In the present embodiment, the addition rate of ozone O₃ to the first ozone reaction tank 15 and the second ozone reaction tank 16 is defined as Ad_O₃ (hereinafter, referred to as an ozone addition rate Ad_O₃), and it is assumed that ozone O₃ is distributed to the first ozone reaction tank 15 and the second ozone reaction tank 16 with a ratio of 1:1. In addition, when there are three or more ozone reaction tanks, equal distribution is performed.

The control apparatus 25 first determines the ozone addition rate Ad_O₃ and the first hydrogen peroxide addition rate Ad_PH_1 in accordance with the water quality of the water LQ to be treated flowing into the first ozone reaction tank 15.

In this process, the ratio of the first hydrogen peroxide addition rate Ad_PH_1 to the ozone addition rate Ad_O₃ is defined as K1, and the ratio K1 is made constant. The value of this ratio K1 is preferably determined in a range of 1 to 5.

Consequently, the first hydrogen peroxide addition rate Ad_PH_1 is defined by the following expression based on the ozone addition rate Ad_O₃ and the ratio K1:

Ad_PH_1=K1·Ad_O₃

In this case, examples of the method for determining the ozone addition rate Ad_O₃ and the ratio K1 include a method of performing an experiment with the addition rate changed by a beaker test or the like in advance to determine an appropriate addition rate.

It is assumed that no significant water quality changes occur in the influent water LQ to be treated, and it is preferable that the addition rate be reconsidered with appropriate frequency as needed.

When the water quality of the influent water LQ to be treated is measured in real time as in embodiments described below, the ozone addition rate Ad_O₃ and the ratio K1 are changed in conjunction with influent water quality. Effectively, there is no problem with the ratio K1 being constant, and, in this case, when the ozone addition rate Ad_O₃ is changed in conjunction with the influent water quality, the first hydrogen peroxide addition rate Ad_PH_1 is determined accordingly.

The following describes determination of the second hydrogen peroxide addition rate Ad_PH_2.

As described above, the ozone addition rate Ad_O₃ and the first hydrogen peroxide addition rate Ad_PH_1 are determined in accordance with the water quality of the influent water LQ to be treated; depending on actual reaction progress in the first ozone reaction tank 15, the remaining hydrogen peroxide may be insufficient relative to ozone added in the second ozone reaction tank 16.

The dissolved ozone concentration measured by the dissolved ozone concentration meter 18 is defined as DO₃; when the dissolved ozone concentration DO₃ exceeds a threshold, it is determined that the amount of remaining hydrogen peroxide that can be used for the treatment in the second ozone reaction tank 16 is small, and the second hydrogen peroxide addition rate Ad_PH_2 is made a positive value to supply additional hydrogen peroxide from the second hydrogen peroxide supply apparatus 19.

The second hydrogen peroxide addition rate Ad_PH_2 is calculated as a function with the dissolved ozone concentration DO₃ as a parameter. Using a proportional function as the function, the second hydrogen peroxide addition rate Ad_PH_2 is increased, for example. As this function, a stepwise increasing function can also be used.

When a proportional coefficient of the proportional function is K2, for example,

it may be determined that

the second hydrogen peroxide addition rate Ad_PH_2=K2·DO₃ or

the second hydrogen peroxide addition rate Ad_PH_2=K2·DO₃—threshold of DO₃.

The control apparatus 25 then supplies the hydrogen peroxide HP2 corresponding to the calculated hydrogen peroxide amount by controlling the second hydrogen peroxide supply apparatus 19.

Consequently, in the second ozone reaction tank 16, sufficient OH radicals required for the advanced oxidation treatment are generated, the advanced oxidation treatment is performed, and thus a decomposition rate of musty substances and the like is increased. In addition, in the second ozone reaction tank 16, owing to reducing action on bromic acid by hydrogen peroxide, the water LQ to be treated that has been treated while reducing bromic acid generation risk is flowed out of the outflow channel 24.

As in the above description, according to the first embodiment, the necessity of injection and the injection amount of the additional hydrogen peroxide can be determined based on the dissolved ozone concentration at the time of passing through the introduction channel 17 as the outlet of the first ozone reaction tank 15 as an indicator, and therefore a shortage of addition of hydrogen peroxide in the advanced oxidation treatment can be avoided.

### First Modification of First Embodiment

Although the above describes a case in which two ozone reaction tanks (the first ozone reaction tank 15 and the second ozone reaction tank 16) are provided in a direction from inflow to outflow as an example, a case in which three or more ozone reaction tanks are present can also be used in a similar way.

In this case, the dissolved ozone concentration meter and the hydrogen peroxide supply apparatus can be provided each between all the reaction tanks, or one dissolved ozone concentration meter and one hydrogen peroxide supply apparatus can be provided for the entire advanced oxidation water treatment system between the last reaction tank and one immediately before the last one.

More specifically, when there is a first ozone reaction tank to a third ozone reaction tank, the dissolved ozone concentration meter and the hydrogen peroxide supply apparatus may be provided each between the first ozone reaction tank and the second ozone reaction tank and between the second ozone reaction tank and the third ozone reaction tank. Alternatively, the dissolved ozone concentration meter and the hydrogen peroxide supply apparatus can be provided only between the second ozone reaction tank and the third ozone reaction tank.

Consequently, the entire advanced oxidation water treatment system 10 can perform treatment with an optimum ozone/hydrogen peroxide ratio.

### Second Modification of First Embodiment

Although the above describes a case in which two ozone reaction tanks (the first ozone reaction tank 15 and the second ozone reaction tank 16) are provided in the direction from inflow to outflow as an example, even a case in which only one ozone reaction tank is provided without being physically separated into a plurality of tanks can be used.

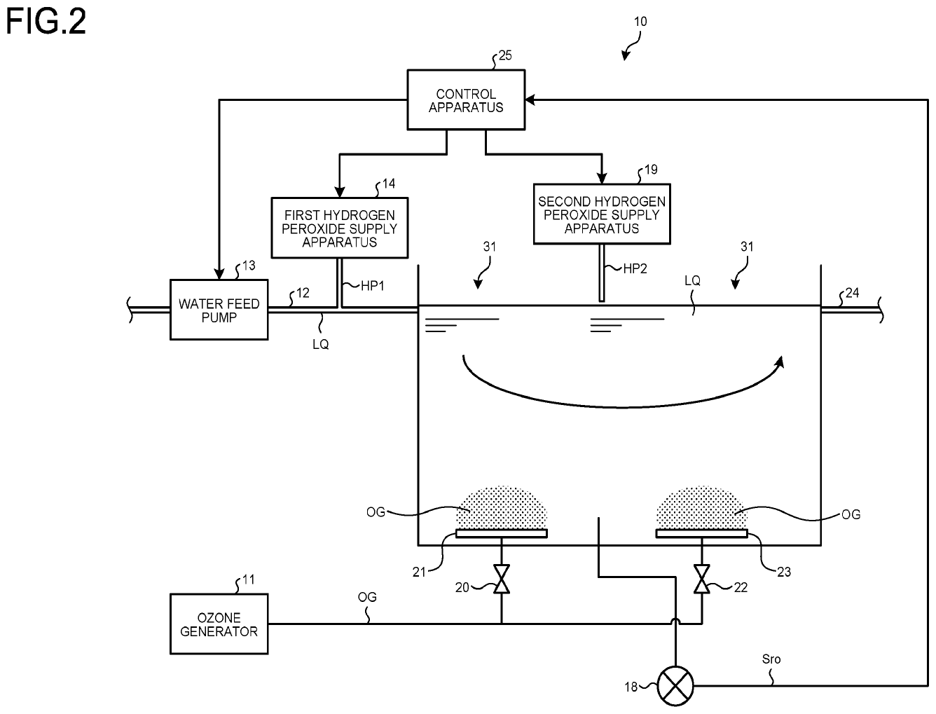

FIG. 2 is an illustrative diagram of the advanced oxidation water treatment system when one ozone reaction tank is provided.

In FIG. 2, parts similar to those in FIG. 1 are denoted by the same symbols.

FIG. 2 is different from FIG. 1 in that one ozone reaction tank 31 is included in place of the first ozone reaction tank 15 and the second ozone reaction tank 16 and that the second hydrogen peroxide supply apparatus 19 and the dissolved ozone concentration meter are provided at an intermediate point of the passage of the water LQ to be treated in the channel of the water LQ to be treated of the ozone reaction tank 31.

In this case, “the intermediate point of the passage of the water LQ to be treated in the channel of the water LQ to be treated” is set as a position corresponding to 30% to 70% of the whole in terms of residence time along a flow direction (with the time of introduction being 0% and the time of derivation being 100%).

Further, FIG. 2 is different from FIG. 1 in that the first gas diffusion unit 21 is provided at an upstream side (the inflow side of the water LQ to be treated) of the point at which the second hydrogen peroxide supply apparatus 19 and the dissolved ozone concentration meter are provided, whereas the second gas diffusion unit 23 is provided at a downstream side (the outflow side of the water LQ to be treated) of the point at which the second hydrogen peroxide supply apparatus 19 and the dissolved ozone concentration meter are provided.

Also according to the second modification of the first embodiment, so that the control apparatus 25 sets optimum additional addition amount of hydrogen peroxide, the dissolved ozone concentration meter 18 measures the dissolved ozone concentration of the water to be treated, flowing from an upstream side of a point at which the second hydrogen peroxide supply apparatus 19 and the dissolved ozone concentration meter 18 are provided in the ozone reaction tank 31, and outputs the dissolved ozone concentration measurement signal Sro to the control apparatus 25.

The control apparatus 25 then calculates a hydrogen peroxide amount corresponding to a shortage of the hydrogen peroxide initially supplied based on the dissolved ozone concentration measurement signal Sro, that is, a shortage of OH radicals based on the difference between the measured dissolved ozone concentration and a normal dissolved ozone concentration. The control apparatus 25 controls the second hydrogen peroxide supply apparatus 19 to supply hydrogen peroxide corresponding to the calculated hydrogen peroxide amount.

Consequently, at the downstream side of the point at which the second hydrogen peroxide supply apparatus 19 and the dissolved ozone concentration meter 18 are provided in the ozone reaction tank 31, sufficient OH radicals required for the advanced oxidation treatment are generated, the advanced oxidation treatment is performed, and thus the decomposition rate of musty substances and the like is increased, and in addition, owing to reducing action on bromic acid by hydrogen peroxide, the water LQ to be treated that has been treated while reducing the bromic acid generation risk is flowed out of the outflow channel 24.

### Third Modification of First Embodiment

Although the above describes an embodiment when the water to be treated flows through the ozone reaction tank in a horizontal direction, a third modification of the first embodiment is an embodiment when the water LQ to be treated flows in a vertical direction.

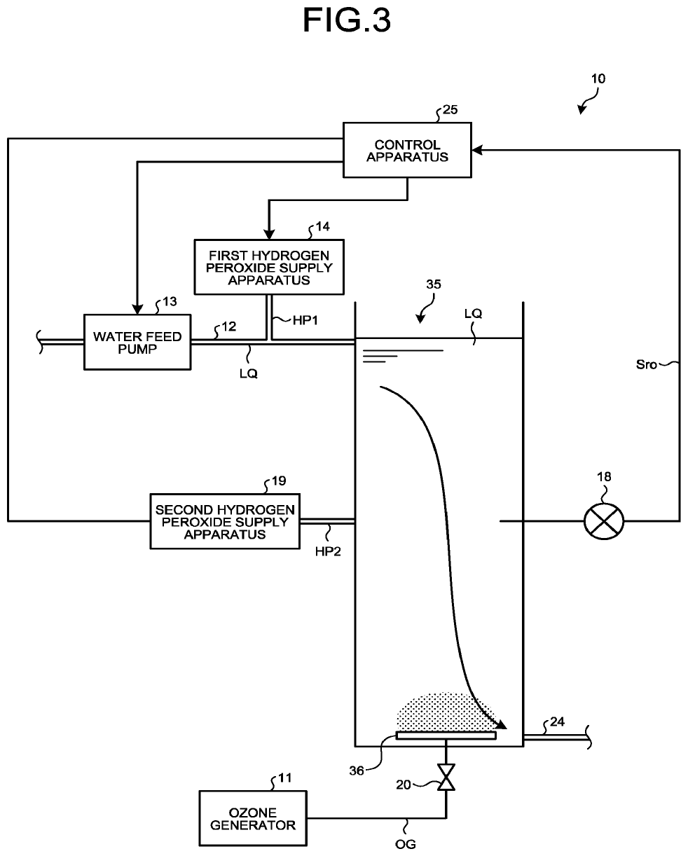

FIG. 3 is an illustrative diagram of the advanced oxidation water treatment system when the water to be treated flows through the ozone reaction tank in the vertical direction.

In FIG. 3, parts similar to those in FIG. 1 are denoted by the same symbols.

FIG. 3 is different from FIG. 1 in that one ozone reaction tank 35 long in the vertical direction is included in place of the first ozone reaction tank 15 and the second ozone reaction tank 16 and that the second hydrogen peroxide supply apparatus 19 and the dissolved ozone concentration meter 18 are provided at an intermediate point in a height direction (an up-and-down direction) of the passage of the water LQ to be treated in the channel of the water LQ to be treated of the ozone reaction tank 35.

In this case, “the intermediate point in the height direction (the up-and-down direction) of the passage of the water LQ to be treated in the channel of the water LQ to be treated” is a position in the water with an effective height of 30% to 60% from the bottom in the height direction (with the bottom being 0% and an introduction part being 100%).

The dissolved ozone concentration meter 18 is installed at a place where the dissolved ozone concentration meter 18 can measure the dissolved ozone concentration of the water LQ to be treated which does not contain the hydrogen peroxide supplied by the second hydrogen peroxide supply apparatus 19. Thus, a measurement position of the dissolved ozone concentration meter 18 is provided at a position such that the water LQ to be treated is measured by the dissolved ozone concentration meter 18 at an upstream side (an upper side in the up-and-down direction) of the water LQ to be treated to which hydrogen peroxide will be added by the second hydrogen peroxide supply apparatus 19.

FIG. 3 is different from FIG. 1 also in that only one gas diffusion unit 36 is provided at the bottom of the ozone reaction tank 35 in place of the first gas diffusion unit 21 and the second gas diffusion unit 23.

Also according to the third modification of the first embodiment, so that the control apparatus 25 sets optimum additional addition amount of hydrogen peroxide (the amount of the hydrogen peroxide HP2), the dissolved ozone concentration meter 18 measures the dissolved ozone concentration of the water LQ to be treated, flowing from an upstream side of a point at which the second hydrogen peroxide supply apparatus 19 and the dissolved ozone concentration meter 18 are provided in the ozone reaction tank 35.

The control apparatus 25 then calculates a hydrogen peroxide amount corresponding to a shortage of the hydrogen peroxide initially supplied, that is, a shortage of OH radicals based on the difference between the measured dissolved ozone concentration and a normal dissolved ozone concentration. The control apparatus 25 controls the second hydrogen peroxide supply apparatus 19 to supply the hydrogen peroxide HP2 corresponding to the calculated hydrogen peroxide amount.

Consequently, at the downstream side of the point at which the second hydrogen peroxide supply apparatus 19 and the dissolved ozone concentration meter 18 are provided in the ozone reaction tank 35, sufficient OH radicals required for the advanced oxidation treatment are generated. The advanced oxidation treatment is performed on the water LQ to be treated, and thus the decomposition rate of musty substances and the like is increased. In addition, owing to reducing action on bromic acid by hydrogen peroxide, the water LQ to be treated that has been treated while reducing the bromic acid generation risk is flowed out of the outflow channel 24.

Although the above describes a configuration in which the first hydrogen peroxide supply apparatus 14 supplies the hydrogen peroxide HP1 via the inflow channel 12, the hydrogen peroxide HP1 can also be supplied onto the surface of the water or to the vicinity of the surface of the water of the ozone reaction tank 35.

### Second Embodiment

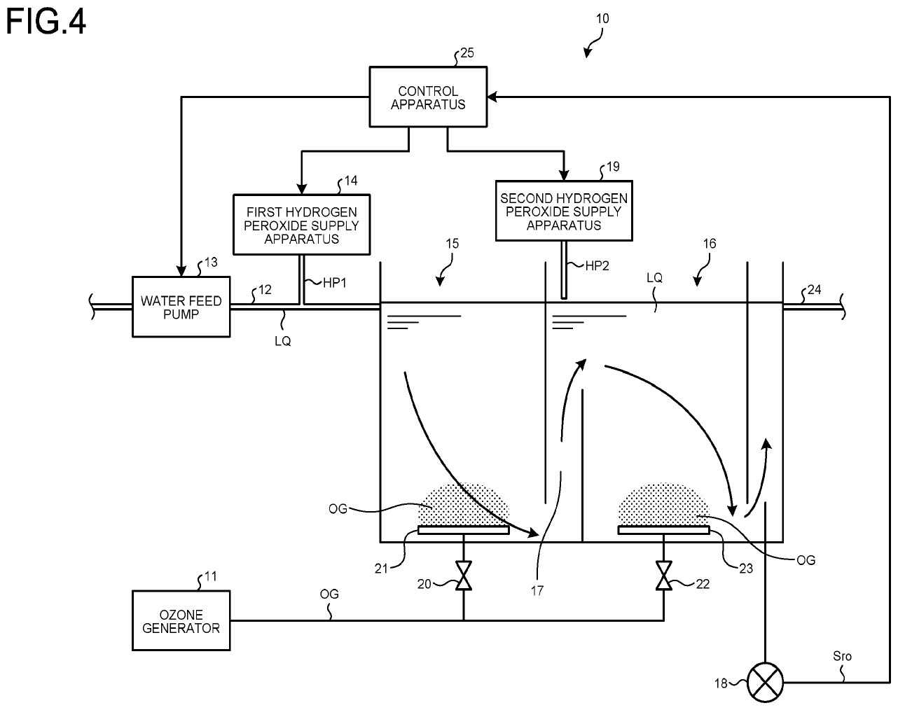

FIG. 4 is a schematic diagram illustrating a configuration of the advanced oxidation water treatment system of a second embodiment.

In FIG. 4, parts similar to those of the first embodiment in FIG. 1 are denoted by the same symbols.

The second embodiment is different from the first embodiment in that the dissolved ozone concentration meter 18 is placed at a downstream side (a treated water outlet or near the treated water outlet) of the second ozone reaction tank 16.

Thus, whether hydrogen peroxide is insufficient in the second ozone reaction tank 16 is determined, and the addition amount of hydrogen peroxide is determined from the final dissolved ozone concentration of the water LQ to be treated.

When the consumption of hydrogen peroxide in the first ozone reaction tank 15 exceeds a normally estimated amount (the amount of the hydrogen peroxide HP1 at the normal time set in the first hydrogen peroxide supply apparatus 14), hydrogen peroxide becomes insufficient relative to the ozonized gas OG to be added in the second ozone reaction tank 16. In this process, like the dissolved ozone concentration at the outlet of the first ozone reaction tank 15, the dissolved ozone concentration at an outlet of the second ozone reaction tank 16 is also a value larger than a case in which the amount of hydrogen peroxide is appropriate.

Given these circumstances, the dissolved ozone concentration at the outlet of the second ozone reaction tank 16 is measured by the dissolved ozone concentration meter 18 to be an indicator. With this operation, the necessity of injection of the additional hydrogen peroxide (the hydrogen peroxide HP2 in the second hydrogen peroxide supply apparatus 19) can be determined, and the addition amount thereof can be determined.

The following describes setting of the second hydrogen peroxide addition rate Ad_PH_2 as the addition amount per unit water amount of the hydrogen peroxide to be supplied by the second hydrogen peroxide supply apparatus 19.

In the first embodiment, the second hydrogen peroxide addition rate Ad_PH_2 is set based on the ozone amount remaining in the first ozone reaction tank 15, whereas in the second embodiment, the setting is based on the ozone amount remaining in the second ozone reaction tank 16. Given these circumstances, the dissolved ozone concentration DO₃ measured by the dissolved ozone concentration meter 18 is the dissolved ozone concentration DO₃ in the water LQ to be treated in the second ozone reaction tank 16 after hydrogen peroxide is supplied by the second hydrogen peroxide supply apparatus 19. This means that when the dissolved ozone concentration DO₃ exceeds a certain threshold, the second hydrogen peroxide addition rate Ad_PH_2 was extremely low. Thus, by performing the feedback control, the amount of the second hydrogen peroxide addition rate Ad_PH_2 is to be controlled so that the dissolved ozone concentration DO₃ becomes the threshold or less.

With this operation, the second embodiment can add the additional hydrogen peroxide as needed so as not to be insufficient relative to ozone to be added via the second gas diffusion unit 23 in the second ozone reaction tank 16 and avoid a shortage of addition of hydrogen peroxide.

### Modification of Second Embodiment

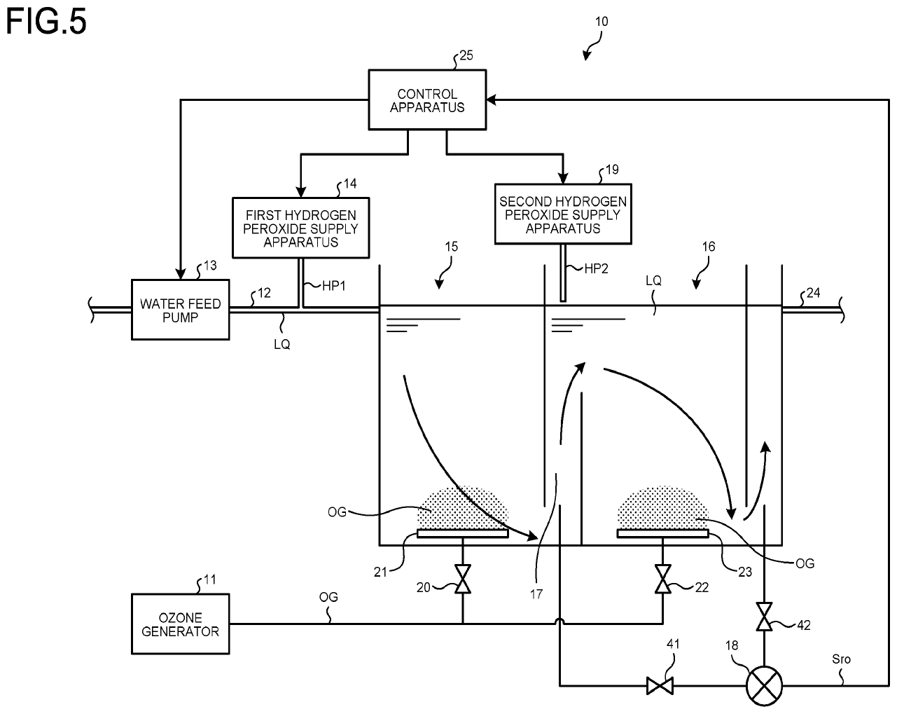

FIG. 5 is a schematic diagram illustrating a configuration of the advanced oxidation water treatment system according to a modification of the second embodiment.

In FIG. 5, parts similar to those of the second embodiment in FIG. 4 are denoted by the same symbols.

In the second embodiment, the dissolved ozone concentration meter 18 is placed at the downstream side (the treated water outlet or near the treated water outlet) of the second ozone reaction tank 16 in place of the dissolved ozone concentration meter 18 measuring the dissolved ozone concentration in the water to be treated, introduced to the introduction channel 17 after passing through the first ozone reaction tank 15 in the first embodiment. On the other hand, the present modification is provided with a first valve 41 connecting the dissolved ozone concentration meter 18 to the introduction channel 17 and a second valve 42 connecting the dissolved ozone concentration meter to the downstream side of the second ozone reaction tank 16. The control apparatus 25 exclusively makes the first valve 41 and the second valve 42 to be in an open state or in a closed state, thereby being able to use the dissolved ozone concentration meter 18 in a switched manner between a case described in the first embodiment and a case described in the second embodiment, and can thus perform control of the additional hydrogen peroxide more accurately.

### Third Embodiment

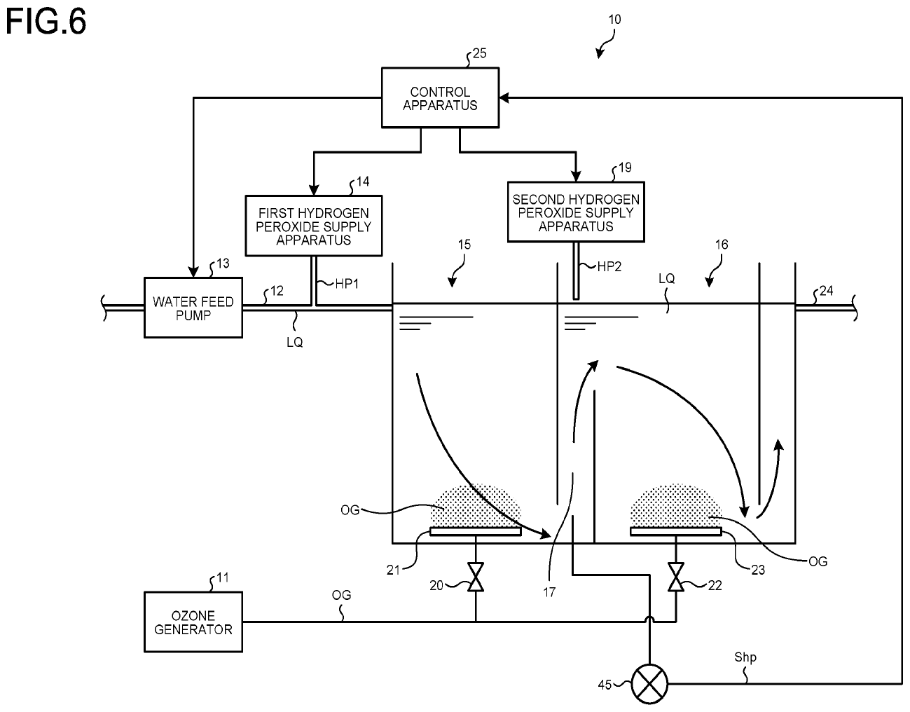

FIG. 6 is a schematic diagram illustrating a configuration of the advanced oxidation water treatment system of a third embodiment.

FIG. 6 is different from the first embodiment in FIG. 1 in that a hydrogen peroxide concentration meter 45 measuring a hydrogen peroxide concentration and outputting a hydrogen peroxide concentration measurement signal Shp is installed in place of the dissolved ozone concentration meter 18.

When the consumption of hydrogen peroxide exceeds an estimated amount in the first ozone reaction tank 15, hydrogen peroxide becomes insufficient relative to ozone added by the second gas diffusion unit 23 in the second ozone reaction tank 16. Consequently, the hydrogen peroxide concentration has a value lower than the estimated concentration at the normal time in the introduction channel 17 at a downstream side of the first ozone reaction tank 15.

Given these circumstances, in the third embodiment, the control apparatus 25 determines whether hydrogen peroxide should be additionally supplied and determines an addition amount with the hydrogen peroxide concentration corresponding to the hydrogen peroxide concentration measurement signal Shp measured and output by the hydrogen peroxide concentration meter 45 as an indicator.

The third embodiment determines excess or deficiency of hydrogen peroxide directly from the remaining hydrogen peroxide concentration and can thus accurately control the additional addition amount of hydrogen peroxide.

### Fourth Embodiment

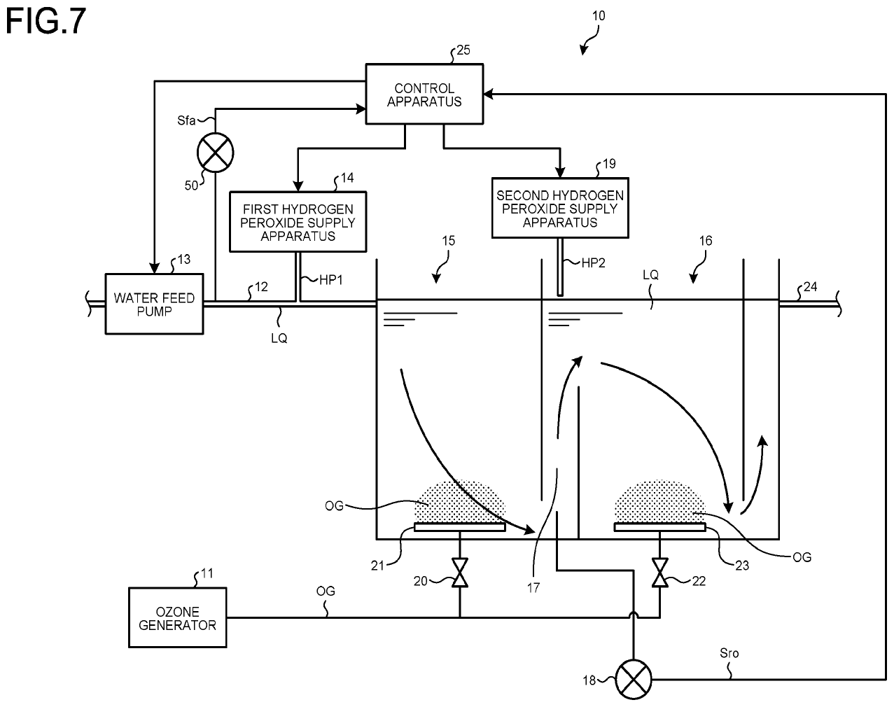

FIG. 7 is a schematic diagram illustrating a configuration of the advanced oxidation water treatment system of a fourth embodiment.

FIG. 7 is different from the first embodiment FIG. 1 in that a fluorescence analyzer 50 irradiating the water LQ to be treated with excitation light to measure fluorescence intensity and to output a fluorescence analysis signal Sfa is provided in the inflow channel 12.

The fluorescence analyzer 50 measures the intensity of fluorescence (around a wavelength of 425 nm) relative to the excitation light (around a wavelength of 345 nm) and outputs the fluorescence analysis signal Sfa.

Considering a case in which the advanced oxidation water treatment system 10 is used for a tap water process, for example, measurement of this fluorescence intensity corresponds to measuring the amount of naturally occurring organic matter (referred to as fulvic acid-like organic matter or the like) of taken source water. That is, a measurement result by the fluorescence analyzer 50 has correlation with a representative indicator E260 (absorbance) of organic matter concentration, total organic carbon (TOC), trihalomethane forming potential, and the like.

With this correlation, the control apparatus 25 grasps an organic matter concentration in the water to be decomposed in the advanced oxidation treatment by the fluorescence intensity of the water LQ to be treated corresponding to the fluorescence analysis signal Sfa.

Thus, the control apparatus 25 controls the addition amount of the ozonized gas OG with the obtained fluorescence intensity as an indicator. More specifically, when the fluorescence intensity is larger, the addition amount of the ozonized gas OG is increased, whereas when the fluorescence intensity is smaller, the addition amount of the ozonized gas OG is decreased.

Specifically, like the method described above, the ozone addition rate Ad_O₃ is calculated in conjunction with the fluorescence intensity of the water LQ to be treated, and based on the certain ratio K1, the first hydrogen peroxide addition rate Ad_PH_1 is calculated.

For the second hydrogen peroxide addition rate Ad_PH_2, a method similar to that described above in the first embodiment may be used.

Further, the control apparatus 25 normally fixes (makes constant) the ratio of the addition amount of hydrogen peroxide to the ozone addition amount based on an analysis result of the fluorescence analyzer 50. The ratio is preferably about 1 to 5 in terms of molar ratio, for example, and the ratio is preferably determined such that hydrogen peroxide is neither insufficient nor excessive relative to ozone added in the second ozone reaction tank 16. The ratio of the addition amount of hydrogen peroxide to the ozone addition amount can also be changed by an operator in accordance with situations such as water quality.

The fourth embodiment can determine the ozone concentration to be supplied by the first hydrogen peroxide supply apparatus 14 based on the organic matter concentration in the water of the water LQ to be treated and besides determines the necessity of injection of the additional hydrogen peroxide (the hydrogen peroxide HP2 to be injected by the second hydrogen peroxide supply apparatus 19) and, if injection is necessary, can determine the addition amount of hydrogen peroxide with the dissolved ozone concentration at the outlet of the first ozone reaction tank 15 as an indicator. Consequently, the supply amount of hydrogen peroxide in the first ozone reaction tank 15 is made more accurate, and the advanced oxidation treatment can be performed in the first ozone reaction tank 15 more surely. Further, the advanced oxidation treatment can be performed more surely while reducing the supply amount of hydrogen peroxide in the second ozone reaction tank 16.

### Fifth Embodiment

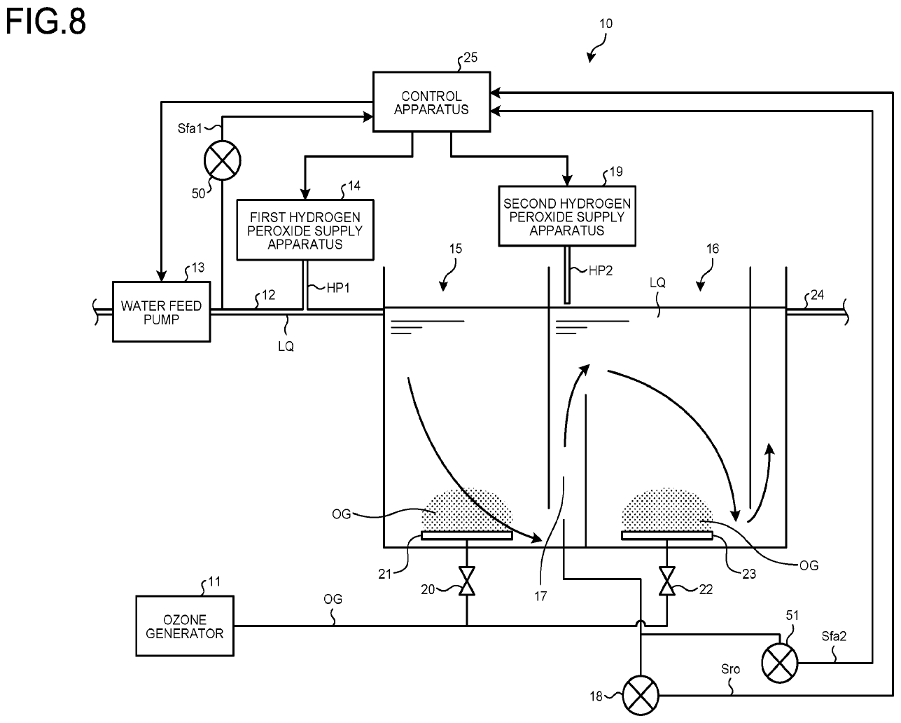

FIG. 8 is a schematic diagram illustrating a configuration of the advanced oxidation water treatment system of a fifth embodiment.

The fifth embodiment is different from the fourth embodiment in FIG. 7 in that, in addition to the configuration of the fourth embodiment, a fluorescence analyzer 51 is included that irradiates the water LQ to be treated at the outlet of the first ozone reaction tank 15 with excitation light to measure fluorescence intensity and to output a fluorescence analysis signal Sfa2, and the supply amount of hydrogen peroxide is controlled based on a fluorescence analysis signal Sfa1 output by the fluorescence analyzer 50 and the fluorescence analysis signal Sfa2 output by the fluorescence analyzer 51. The fluorescence analyzer 51 measures the intensity of fluorescence (around a wavelength of 425 nm) relative to the excitation light (around a wavelength of 345 nm) like the fluorescence analyzer 50.

With this configuration, the control apparatus 25 grasps the status of the advanced oxidation treatment in the first ozone reaction tank 15 and the second ozone reaction tank 16 from changes in fluorescence intensity corresponding to the fluorescence analysis signal Sfa1 output by the fluorescence analyzer 50 and fluorescence intensity corresponding to the fluorescence analysis signal Sfa2 output by the fluorescence analyzer 51 and performs feedback control on the addition amount of the ozonized gas OG.

In this case, as the changes in the fluorescence intensity, the ratio between the fluorescence intensity corresponding to the fluorescence analysis signal Sfa1 and the fluorescence intensity corresponding to the fluorescence analysis signal Sfa2, that is,

Sfa1/Sfa2

may be determined to be an indicator.

Feedback control is performed so as to make the obtained value a certain constant value, the ozone addition rate Ad_O₃ is calculated, and based on the calculated ozone addition rate Ad_O₃ and the ratio K1, the first hydrogen peroxide addition rate Ad_PH_1 is calculated.

Further, for the second hydrogen peroxide addition rate Ad_PH_2, a method similar to that described above in the first embodiment may be used.

In this case, the ratio of the addition amount of hydrogen peroxide to the addition amount of the ozonized gas OG is normally fixed (constant); the operator can change the ratio of the addition amount of hydrogen peroxide to the addition amount of the ozonized gas OG in accordance with situations such as water quality. More specifically, the ratio is preferably about ⅕ in terms of molar ratio, and the ratio is determined such that hydrogen peroxide is neither insufficient nor excessive relative to ozone added in the second ozone reaction tank 16. That is, with the dissolved ozone concentration at the outlet of the first ozone reaction tank 15 corresponding to the dissolved ozone concentration measurement signal Sro output by the dissolved ozone concentration meter 18 as an indicator, the necessity of injection of the additional hydrogen peroxide (the hydrogen peroxide HP2 of the second hydrogen peroxide supply apparatus) can be determined, and the addition amount thereof can be determined.

The fifth embodiment, in addition to the effect of the fourth embodiment, can determine the necessity of injection and the addition amount of the hydrogen peroxide HP2 to be supplied by the second hydrogen peroxide supply apparatus 19 based on the organic matter concentration in the water of the water LQ to be treated after passing through the first ozone reaction tank 15 and being treated and can thus perform the advanced oxidation treatment more surely while reducing the supply amount of hydrogen peroxide in the second ozone reaction tank 16.

### Sixth Embodiment

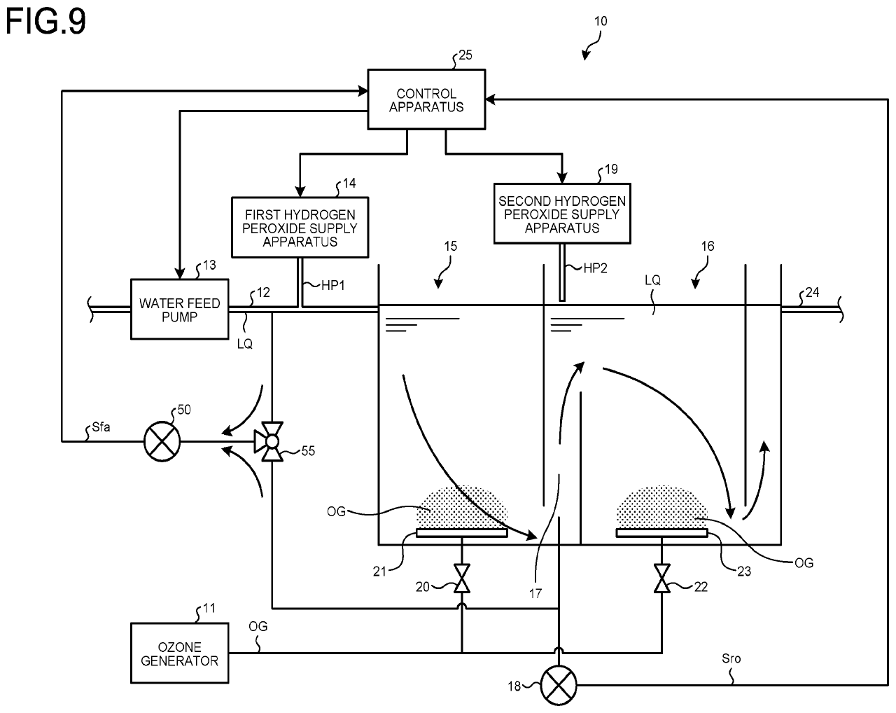

FIG. 9 is a schematic diagram illustrating a configuration of the advanced oxidation water treatment system of a sixth embodiment.

The sixth embodiment uses only one fluorescence analyzer 50 unlike the configuration having the two fluorescence analyzers 50 and 51 of the fifth embodiment and automatically switches a three-way valve 55 by the control apparatus 25 to change water to be measured, thus performing control similar to that of the fifth embodiment.

The reason why such a configuration is feasible is that the fluorescence analyzer 50 is an optical measurement instrument and requires not much time for measurement and can perform measurement in a few seconds or about 1 minute at most even when averaging processing such as averaging movement for reducing fluctuations of a measurement result is performed, for example.

Thus, when the residence time of the water LQ to be treated in the first ozone reaction tank 15 is about 5 minutes or more, for example, a water quality change also occurs in about 5 minutes, and the fluorescence intensity of the water LQ to be treated and at the outlet of the first ozone reaction tank 15 can sufficiently be measured even when the water to be measured is changed by the automatic switching of the valve simply by providing one fluorescence analyzer 50. In the example described above, the residence time of the first ozone reaction tank 15 is 5 minutes, and three-way valve switching timing is set to every 5 minutes, thereby enabling measurement.

### Seventh Embodiment

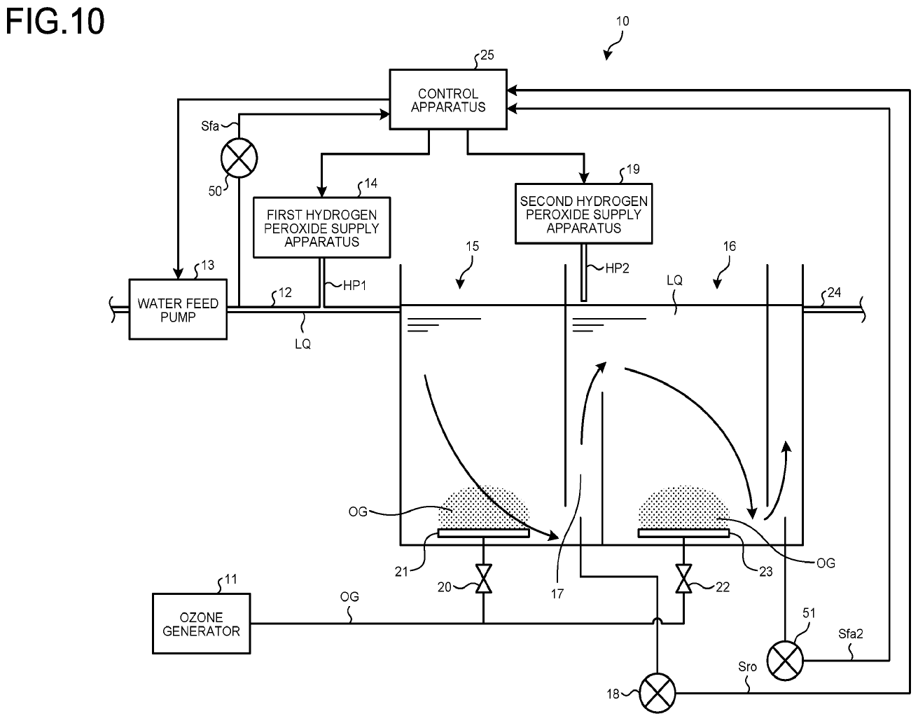

FIG. 10 is a schematic diagram illustrating a configuration of the advanced oxidation water treatment system of a seventh embodiment.

The seventh embodiment is different from the fifth embodiment in that the fluorescence analyzer 51 is configured to irradiate the water LQ to be treated at the outlet of the second ozone reaction tank 16 with excitation light to measure the fluorescence intensity and to output the fluorescence analysis signal Sfa2.

The seventh embodiment can grasp the status of the advanced oxidation treatment in the ozone reaction tank with the first ozone reaction tank 15 and the second ozone reaction tank 16 integrated with each other from changes in the fluorescence intensity of the supplied water LQ to be treated (corresponding to the fluorescence analysis signal Sfa1) and the fluorescence intensity at the outlet of the second ozone reaction tank 16 (corresponding to the fluorescence analysis signal Sfa2) and perform feedback control on the ozone addition amount.

Also in this case, the fluorescence intensity corresponding to the fluorescence analysis signal Sfa1/the fluorescence intensity corresponding to the fluorescence analysis signal Sfa2 is determined to be an indicator, and feedback control is performed such that this value is a certain constant value.

In this case, the value of the indicator is smaller, and a time from when the addition amount of the ozonized gas is changed until when the indicator starts to change is longer than those of the fifth embodiment.

### Modification of Embodiments

Although the fluorescence analyzer 50 and in addition the fluorescence analyzer 51 as needed are used in the fourth embodiment to the seventh embodiment, an absorptiometer (around a wavelength of 260 nm, for example) or a total organic carbon (TOC) meter can be installed in place of the fluorescence analyzers 50 and 51.

In this case, when the absorptiometer is used, the sensitivity of absorbance is lower than that of the fluorescence intensity, and thus it is required to be used in consideration of that point. In addition, also detecting dissolved ozone, the absorptiometer is not suitable for a case in which water in a part with a high dissolved ozone concentration is measured.

TOC changes and decreases when the advanced oxidation treatment sufficiently decomposes organic matter components in the water, and thus the TOC meter can be used.

The control apparatus 25 of the advanced oxidation water treatment system 10 of the present embodiment can include a controller such as a micro processing unit (MPU), storage devices such as a read only memory (ROM) and a random access memory (RAM), external storage devices such as a solid-state drive (SSD), a hard disk drive (HDD), and a compact disc (CD) drive apparatus, a display device such as a display, and input devices such as a keyboard and a mouse, for example, and has a hardware configuration using a normal computer.

A computer program executed by the control apparatus 25 of the advanced oxidation water treatment system 10 of the present embodiment is recorded and provided in a computer-readable recording medium such as a compact disc read only memory (CD-ROM), a digital versatile disc (DVD), and a semiconductor storage device such as a Universal Serial Bus (USB) memory as an installable or executable file.

The computer program executed by the control apparatus 25 of the advanced oxidation water treatment system 10 of the present embodiment may be stored in a computer connected to a network such as the Internet and provided by being downloaded via the network. The computer program executed by the control apparatus 25 of the advanced oxidation water treatment system 10 of the present embodiment may be provided or distributed via a network such as the Internet.

The computer program executed by the control apparatus 25 of the advanced oxidation water treatment system 10 of the present embodiment may be embedded and provided in a ROM, for example.

Although several embodiments according to the present invention have been described, these embodiments are presented for illustrative purposes only and are not intended to limit the scope of the invention. These novel embodiments can be implemented in various other forms, and various omissions, substitutions, and modifications can be made within the scope and spirit of the invention. The embodiments and modifications thereto are within the scope and spirit of the invention and are within the invention described in claims and equivalents thereof.

What is claimed is:

1. An advanced oxidation water treatment system comprising:
an ozone reaction tank configured to hold treatment water to be treated;
a first hydrogen peroxide supplier configured to supply hydrogen peroxide to treatment water in a supply line supplying the treatment water to an inlet of the ozone reaction tank;
an ozone generator configured to generate an ozonized gas containing ozone and to supply the ozonized gas to the ozone reaction tank downstream of the inlet;
a second hydrogen peroxide supplier configured to supply additional hydrogen peroxide to the ozone reaction tank downstream of where the ozone generator supplies ozonized gas;
a first meter configured to measure water quality of the treatment water at a first location downstream of the inlet; and
a controller configured to determine whether additional hydrogen peroxide is to be supplied by the second hydrogen peroxide supplier and to determine a supply amount of said any additional hydrogen peroxide to be supplied by the second hydrogen peroxide supplier based on the water quality measured by the first meter, and to control the second hydrogen peroxide supplier.

2. The advanced oxidation water treatment system according to claim 1, wherein
the ozone reaction tank includes a plurality of reaction tanks, and
the first meter measures the water quality of the treatment water after passing through at least one reaction tank.

3. The advanced oxidation water treatment system according to claim 1, further comprising:
a second meter that measures the water quality of the treatment water at a second location downstream of the first location where the first meter measures the water quality; and
the controller determines whether any additional hydrogen peroxide is to be supplied by the second hydrogen peroxide supplier and the supply amount of the said any additional hydrogen peroxide based on a ratio between the water quality measured by the first meter and the water quality measured by the second meter.

4. The advanced oxidation water treatment system according to claim 1, wherein the first meter comprises a dissolved ozone concentration meter, a hydrogen peroxide concentration meter, a fluorescence analyzer, an absorptiometer, or a total organic carbon (TOC) meter.

5. The advanced oxidation water treatment system according to claim 1, wherein
the first meter comprises a dissolved ozone concentration meter, and
the controller determines the supply amount of the hydrogen peroxide in proportion to a dissolved ozone concentration measured by the dissolved ozone concentration meter.

6. The advanced oxidation water treatment system according to claim 1, wherein
the first meter comprises a hydrogen peroxide concentration meter, and
the controller determines the supply amount of the hydrogen peroxide in inverse proportion to a hydrogen peroxide concentration measured by the hydrogen peroxide concentration meter.

7. The advanced oxidation water treatment system according to claim 1, wherein
the first meter comprises a fluorescence analyzer that measures fluorescence intensity proportional to a concentration of an organic matter contained in the treatment water, and
the controller sets a supply amount of the ozonized gas and the supply amount of the hydrogen peroxide based on the fluorescence intensity.

8. The advanced oxidation water treatment system according to claim 1, wherein
the first meter comprises a single fluorescence analyzer that measures fluorescence intensities at a plurality of measurement sites or a plurality of fluorescence analyzers that measures fluorescence intensities at respective different measurement sites, and
the controller sets the supply amount of the ozonized gas and the supply amount of the hydrogen peroxide based on a fluorescence intensity ratio of the measurement sites.

9. The advanced oxidation water treatment system according to claim 7, wherein the fluorescence analyzer has a wavelength range including a wavelength of 345 nm for an excitation wavelength and has a wavelength range including a wavelength of 425 nm for a measurement wavelength of the fluorescence intensity.

10. The advanced oxidation water treatment system according to claim 1, wherein
the first meter comprises an absorptiometer that measures absorbance proportional to a concentration of an organic matter contained in the treatment water as the treatment indicator, and
the controller sets a supply amount of the ozonized gas and the supply amount of the hydrogen peroxide based on the absorbance.

11. The advanced oxidation water treatment system according to claim 1, wherein
the first meter comprises a single absorptiometer that measures absorbances at a plurality of measurement sites or a plurality of absorptiometers that measures absorbances at respective different measurement sites, wherein
the controller sets the supply amount of the ozonized gas and the supply amount of the hydrogen peroxide based on an absorbance ratio of the measurement sites.

12. The advanced oxidation water treatment system according to claim 10, wherein the absorptiometer has a wavelength range including a wavelength of 260 nm for a measurement wavelength of the absorbance.

13. The advanced oxidation water treatment system according to claim 1, wherein,
the first location where water quality is measured by the first meter is downstream of where the ozone generator supplies ozonized gas to the ozone reaction tank.

14. The advanced oxidation water treatment system according to claim 3, wherein,
the first location where water quality is measured by the first meter is downstream of where the ozone generator supplies ozonized gas; and
the second location where water quality is measured by the second meter is downstream of where the second hydrogen peroxide supplier is to supply any additional hydrogen peroxide.

15. The advanced oxidation water treatment system according to claim 1, wherein:
the ozone generator is configured to supply additional ozonized gas to the ozone reaction tank downstream of where the second hydrogen peroxide supplier is to supply said any additional hydrogen peroxide.

16. The advanced oxidation water treatment system according to claim 15, wherein,
the first location where water quality is measured by the first meter is upstream of where said additional ozonized gas is to be supplied to the ozone reaction tank by the second ozone generator.

17. The advanced oxidation water treatment system according to claim 3, wherein:
the ozone generator is configured to supply additional ozonized gas to the ozone reaction tank downstream of where the second hydrogen peroxide supplier supplies said any additional hydrogen peroxide, and
the second location where water quality is measured by the second meter is downstream of where the ozone generator supplies said additional ozonized gas.

18. A water treatment method comprising:
supplying hydrogen peroxide to treatment water in a supply line supplying the treatment water to an inlet of an ozone reaction tank;
generating an ozonized gas containing ozone and supplying the ozonized gas to treatment water supplied to the ozone reaction tank downstream of the inlet;
measuring, at a first location in the ozone reaction tank downstream of where ozonized gas is supplied, water quality of the treatment water;
determining whether additional hydrogen peroxide is to be supplied to the ozone reaction tank and a supply amount of any additional hydrogen peroxide to be supplied to the ozone reaction tank based on the measured water quality; and
supplying additional hydrogen peroxide to the ozone reaction tank based on the determined supply amount.

19. The water treatment method according to claim 18, further comprising:
measuring water quality of the treatment water in the ozone reaction tank at a second location downstream of where said any additional hydrogen peroxide is to be supplied to the ozone reaction tank; and
determining whether said any additional hydrogen peroxide is to be supplied and the supply amount of said any additional hydrogen peroxide based on a ratio between the water quality measured at the first location and the water quality measured at the second location.

20. The water treatment method according to claim 19, further comprising:
supplying ozonized gas to the ozone reaction tank at a location which is downstream of where said any additional hydrogen peroxide is to be supplied to the ozone reaction tank and which is upstream of the second location where water quality is measured.
